(19) United States
(12) Patent Application Publication
(10) Pub. No.: US 2025/0138811 A1
(43) Pub. Date: May 1, 2025

(54) AVOIDING SERVICE DISRUPTION WHEN UPDATING PLUGIN APPLICATIONS

(71) Applicant: DELL PRODUCTS L.P., Round Rock, TX (US)

(72) Inventors: Michael E. Brown, Austin, TX (US); Marshal Savage, Austin, TX (US); Jitendra Jagasia, Round Rock, TX (US); Jack Fewx, Austin, TX (US); Prashanth Giri, Round Rock, TX (US); Ching-Jye Chang, Cedar Park, TX (US)

(21) Appl. No.: 18/499,996

(22) Filed: Nov. 1, 2023

(51) Int. Cl. G06F 8/656; G06F 8/61

(52) U.S. Cl. CPC G06F 8/656; G06F 8/62

(57) ABSTRACT

An information handling system receives an installation file package to upgrade a first plugin to a second plugin included in the installation file package. In response to determining that a first component identifier of the first plugin matches a second component identifier of the second plugin, the system performs a non-disruptive update process, wherein the first plugin and the second plugin support the non-disruptive update process. The non-disruptive update process includes notifying the first plugin that the non-disruptive update process is starting, installing the second plugin while the first plugin is running, and shutting down the first plugin subsequent to a receipt of a status update from the second plugin that the second plugin is running in a good state.

### FIELD OF THE DISCLOSURE

The present disclosure generally relates to information handling systems, and more particularly relates to avoiding service disruption when updating plugin applications.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system receives an installation file package to upgrade a first plugin to a second plugin included in the installation file package. In response to determining that a first component identifier of the first plugin matches a second component identifier of the second plugin, the system performs a non-disruptive update process, wherein the first plugin and the second plugin support the non-disruptive update process. The non-disruptive update process includes notifying the first plugin that the non-disruptive update process is starting, installing the second plugin while the first plugin is running, and shutting down the first plugin subsequent to a receipt of a status update from the second plugin that the second plugin is running in a good state.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIGS. 2-3 are block diagrams of environments to avoid service disruption when updating plugin applications, according to an embodiment of the present disclosure; and

FIGS. 4-7 are flowcharts of methods to avoid service disruption when updating plugin applications, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

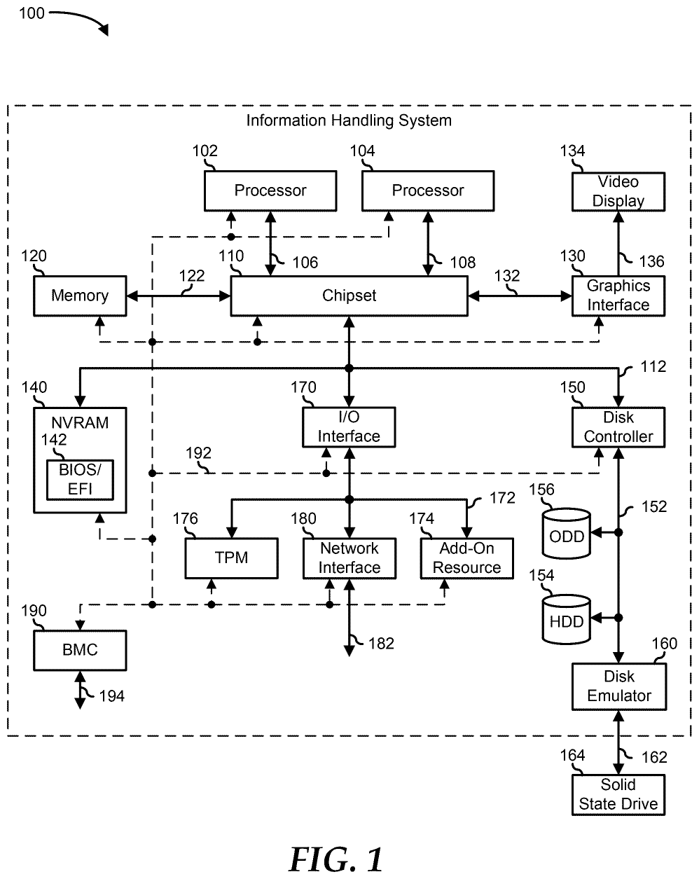

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include a I²C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

A management controller, such as BMC 190 of FIG. 1, provides out-of-band management of an information handling system. In various embodiments management controllers may perform low-level tasks from measuring temperature probes and managing fan speeds, to more medium tasks such as providing a way to change BIOS settings, up through higher-level functions such as acting as “virtual media” for the system to allow for installing an operating system.

Management controller firmware has been implemented as a monolithic firmware image that is developed by the manufacturer, cryptographically signed, and loaded onto the management controller. Thus, a customer has no mechanism to add or remove code in the management controller without updating the whole firmware image. Accordingly updating the management controller firmware can involve delivering a large software package containing all of the updated components, even if only one or a small number of components needs to be updated. This may hinder the adoption of new firmware versions by customers, as the monolithic firmware upgrade package takes a long time to develop, deliver, and upgrade. In addition, the upgrade process is typically disruptive because of downtime as the operation of management controller firmware is stopped and uninstalled before installing a newer version. This poses a problem for mission-critical software where downtime is not permitted.

With a modular management controller firmware, the management controller includes one or more management controller software modules, also referred to as plugin applications or simply plugins. This allows the ability to add, remove, and/or update each plugin. Accordingly the customer can add features, apply a patch, and/or upgrade each plugin to a newer version. However during a usual upgrade process the plugin is uninstalled, and then a newer version plugin is installed. Services provided by the currently installed plugin may be shut down and will be unavailable until the new plugin is fully operational. Accordingly, the services are disrupted until the new plugin is operational. Although the upgrade process may determine whether the new plugin is installable prior to initiating the upgrade process, the new plugin may not be functional after its installation, which further increases the service downtime. This is generally unacceptable in mission-critical environments. To address these and other concerns, the present disclosure provides a non-disruptive update process, wherein the installed plugin remains operational while another plugin is being installed.

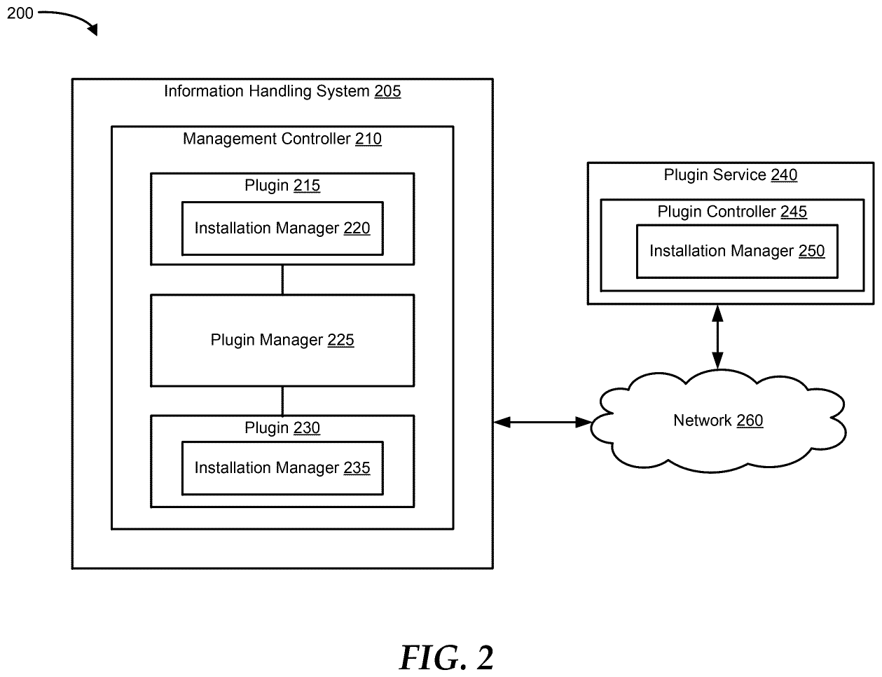

FIG. 2 shows an environment 200 configured to avoid service disruption when updating plugin applications. Environment 200 includes an information handling system 205, a plugin service 240, and a network 260. Network 260 may be a public network, such as the Internet, a physical private network, a wireless network, a virtual private network (VPN), or any combination thereof. Information handling system 205, which is similar to information handling system 100 of FIG. 1, may include a management controller 210 that further includes a plugin 215, a plugin manager 225, and a plugin 230.

Management controller 210, which is similar to BMC 190 of FIG. 1, may be configured to provide management functionality for monitoring, control, and/or management of information handling system 205. Plugin 215 includes an installation manager 220 while plugin 230 includes an installation manager 235. Plugin service 240 includes a plugin controller 245 that further includes an installation manager 250. The components of environment 200 may be implemented in hardware, software, firmware, or any combination thereof. In addition, the components shown are not drawn to scale, and environment 200 may include additional or fewer components. In addition, connections between components may be omitted for descriptive clarity.

Plugin service 240 may be a service provider that may be located remotely in a cloud or premises. Plugin controller 245 may be configured to monitor, manage, and/or control plugins deployed at one or more management controllers of the information handling systems, such as management controller 210. For example, plugin controller 245 may be configured to update plugin 215 with plugin 230, such as by uploading an installation file package. The update may be an upgrade, such that a plugin with a newer version of firmware replaces a currently installed plugin with an older firmware version. The update may also be a downgrade, such that a plugin with an older firmware version replaces a currently installed plugin with an older version of the firmware. In one or more examples herein, an upgrade scenario may be used. However, the system and method may apply to a downgrade scenario also.

Plugin controller 245 may be further configured to communicate with plugins 215 and 230 via installation manager 250 during the update progress and negotiate operations between both plugins via network 260. For example, installation manager 250 may be configured to communicate with installation managers 220 and 235 included in plugins 215 and 230 respectively. This is in addition to installation managers 220 and 235 communicating with each other, such as during the handoff process. Installation managers 220 and 235 may notify installation manager 250 whether its associated plugin has been installed and running in a good state using a remote procedure call. Installation managers 220 and 235 may also notify installation manager 250 whether a services handoff process was successful.

The services handoff process may be performed between two plugins, such that the services currently provided by a first plugin may now be provided by a second plugin. In this example, the first plugin is being replaced by the second plugin. Accordingly, the first plugin may now be safely shut down and/or uninstalled. If at any point during the update process, there is an issue with the second plugin, then the update process may be aborted, and the first plugin may continue with its operations. Thus, the second plugin may be shut down and uninstalled. As such, there may not be a disruption to the services provided during the upgrade process. Installation managers 220 and 235 may be in communication with installation manager 250 at each step in the process.

Plugin manager 225 may be configured to monitor, manage, and control plugins 215 and 230. For example, plugin manager 225 can start, stop, and monitor the operations of plugins 215 and 230. In addition, plugin manager 225 may coordinate the update of plugin 215 to plugin 230 with plugin controller 245. Plugin manager 225 may proceed with the non-disruptive update process when it determines that there is a currently installed plugin with a component identifier that matches the component identifier of the plugin to be installed, that the currently installed plugin includes a manifest with an entry indicating that it supports the non-disruptive update, and the plugin to be installed also includes a manifest with an entry that it supports the non-disruptive update.

The non-disruptive update may be performed such that there is zero or minimal downtime or connection loss prior to the completion of the update process. Accordingly, a handoff process between the currently installed and the newly installed plugin may be performed before a shutdown of one of the plugins. In this example, plugin 215 may be the currently installed plugin while plugin 230 may be the newly installed plugin. At this point, the diagram shows both plugins are installed in management controller 210 prior to the uninstallation of one of the plugins.

Plugin controller 245 may be configured to handle error conditions via plugin manager 225 to determine which of plugins 215 and 230 should be in service and which one of plugins 215 and 230 should be uninstalled. Accordingly, plugin controller and/or plugin manager 225 may determine which one of plugins 215 and 230 remains installed in management controller 210 or which one of plugins 215 and 230 would be installed. Plugin controller 245 may further be configured to either clean up plugin 215 or plugin 230 based on which of the plugins are in a good state if the handoff failed. For example, on reboot, plugin controller 245 via management controller 210 may clean up partially unpacked files associated with the initial installation file package.

For example, if an alternating current (AC) power loss happened before the handoff process was completed, that is before receipt of the handoff success or handoff failure D-Bus signal, then plugin controller 245 via plugin manager 225 may start plugin 215 and restart the upgrade process from the beginning. If the AC power loss happened after the handoff process was completed, that is after receipt of the handoff success or handoff failure D-Bus signal, then plugin controller 245 via plugin manager 225 may start plugin 230 and uninstall plugin 215. For example, after receiving information that plugin 230 is running and in a good state via installation manager 250, plugin controller 245 may put plugin 215 into an uninstall state. After that, plugin manager 225 may continue to uninstall plugin 215. On the other hand, after receiving information that plugin 230 is in a bad state via installation manager 250, plugin controller 245 may put plugin 230 in the uninstall state. In another embodiment, plugin 230 may put itself into the uninstall state.

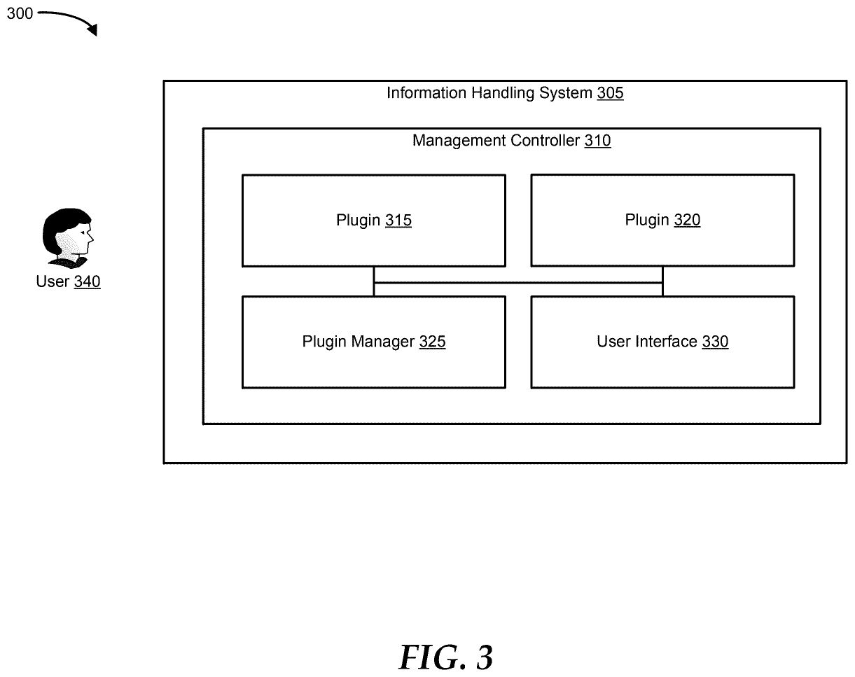

FIG. 3 shows an environment 300 configured to avoid service disruption when updating plugin applications. Environment 300 includes an information handling system 305 and a user 340. Information handling system 305, which is similar to information handling system 205 of FIG. 2, includes a management controller 310. Management controller 310, which is similar to management controller 210 of FIG. 2, includes plugins 315 and 320, a plugin manager 325, and a user interface 330. Plugins 315 and 320 are similar to plugins 215 and 230 in FIG. 2 respectively. Plugin manager 325 is similar to plugin manager 225 of FIG. 2. The components of environment 300 may be implemented in hardware, software, firmware, or any combination thereof. In addition, the components shown are not drawn to scale, and environment 300 may include additional or fewer components. In addition, connections between components may be omitted for descriptive clarity.

User 340 may upload an installation file package to update plugin 315 to plugin 320 using user interface 330. In this example, plugin 320 may be a plugin with a newer software or firmware version of plugin 315 for upgrading plugin 315. In another example, plugin 320 may also be a plugin with an older software or firmware version of plugin 315 for downgrading plugin 315. The installation file package may include a manifest file and a compressed software or firmware image which includes one or more plugin executables and one or more ancillary files, such as a manifest file. The manifest file may be configured to specify features associated with plugin 320, such as runtime configuration, permissions, and user-visible details, such as vendor name, version, dependencies, etc. The manifest file may be implemented in various formats such as a JavaScript Object Notation (JSON) file. After unpacking the installation file package, management controller 310 or plugin manager 325 in particular may proceed to read one or more files included in the package, such as the manifest file prior to proceeding with the update process.

During the update process, management controller 310 or plugin manager 325 may be configured to install the software or the firmware image of plugin 320 onto a management controller storage resource and initiate a start-up of plugin 320. Plugin manager 325 may be configured to monitor, manage, and control plugins 315 and 320. For example, plugin manager 325 may install, start, monitor, stop, and uninstall plugins 315 and 320. In one embodiment, plugin manager 325 may be configured to proceed with the non-disruptive update process when it determines that there is a currently installed plugin with a component identifier that matches the component identifier of the plugin to be installed, that the currently installed plugin includes a manifest with an entry indicating that it supports the non-disruptive update and the plugin to be installed also includes a manifest with an entry that it supports the non-disruptive update. The non-disruptive update may be performed such that there is zero downtime or connection loss prior to the completion of the upgrade process.

Plugins 315 and 320 may be configured to advertise that they support the non-disruptive update process. As such, when plugin manager 325 detects the advertisement, plugin manager 325 may refrain from employing the typical upgrade process and instead utilize the non-disruptive update process by facilitating a handoff process of the services between plugins 315 and 320 as disclosed herein. Accordingly, a handoff process between plugins 315 and 320 may be performed prior to a shutdown of one of the plugins. For example, plugins 315 and 320 at which point one disconnect from the service and the other take over. In one particular example, plugin 315 may notify plugin 320 of its last telemetry transaction and plugin 320 would assume the next one.

Plugin manager 325 may be further configured to communicate with plugins 315 and 320 during the handoff process and negotiations between plugins 315 and 320. For example, plugin manager 325 may be configured to handle error conditions to determine which of plugins 315 and 320 should be in service and which one of plugins 315 and 320 should be uninstalled. Plugin controller 245 may further be configured to either clean up plugin 315 or plugin 320 based on which of the plugins are in a good state if the handoff failed.

Plugin manager 325 may be configured to save the state of the upgrade process, such as the status of plugins 215 and 230. This allows plugin manager 325 to recover the upgrade process in case of disruptions, such as a reboot of management controller 210, a reboot of information handling system 205, an AC power loss, etc. To recover after the AC power loss depends on various scenarios. For example, if the AC power loss happens before the installation file package has been uploaded and unpacked, the user may restart the upgrade process from scratch by uploading the installation package file again.

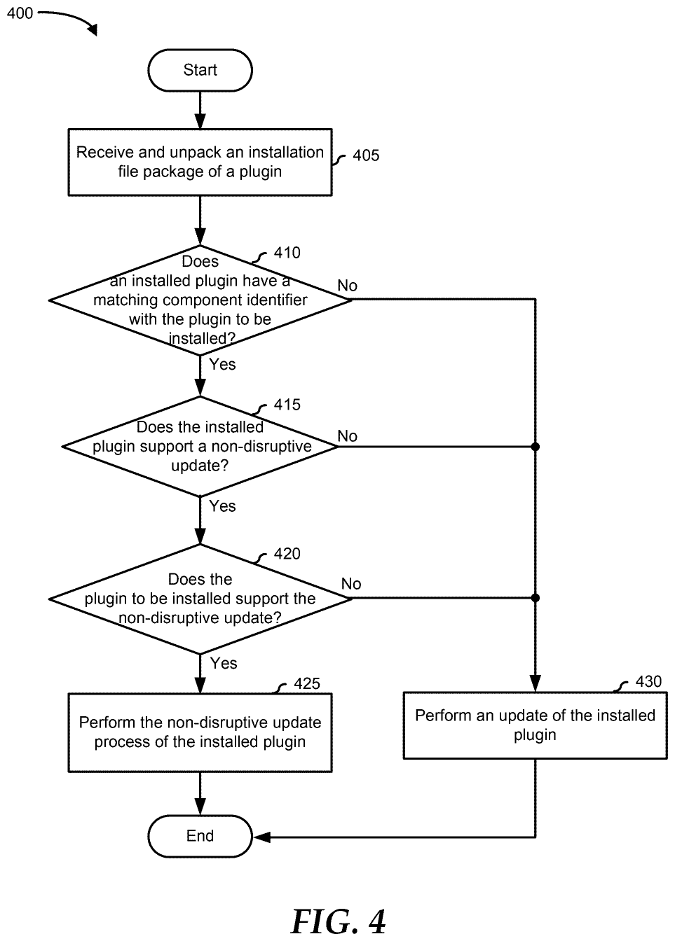

FIG. 4 shows a flowchart of a method 400 for avoiding service disruption when updating plugin applications. Method 400 may be performed by one or more components of environment 200 of FIG. 2 or environment 300 of FIG. 3. However, while embodiments of the present disclosure are described in terms of environments 200 and 300, it should be recognized that other systems may be utilized to perform the described method. One of skill in the art will appreciate that this flowchart explains a typical example, which can be extended to advanced applications or services in practice.

Method 400 typically starts at block 405 where a plugin manager may receive and unpack an installation file package that includes a plugin firmware image. The plugin may be a software module for a management controller of an information handling system. The method may proceed to decision block 410. At decision block 410, the plugin manager may determine whether a component identifier of the plugin currently installed in the information handling system matches a component identifier of the plugin included in the installation file package. If the component identifiers match, then the “YES” branch is taken, and the method proceeds to decision block 415. If the component identifiers do not match, then the “NO” branch is taken, and the method proceeds to block 430.

At decision block 415, the plugin manager may determine whether the installed plugin supports a non-disruptive update process. For example, the method may query an ancillary or manifest file associated with the installed plugin. If the installed plugin supports the non-disruptive update process, then the “YES” branch is taken, and the method proceeds to decision block 420. If the installed plugin does not support the non-disruptive update process, then the “NO” branch is taken, and the method proceeds to block 430.

At decision block 420, the plugin manager may determine whether the plugin to be installed supports the non-disruptive update process. For example, the method may query an ancillary or manifest file included in the installation file package. If the plugin to be installed supports the non-disruptive update process, then the “YES” branch is taken, and the method proceeds to block 425. If the plugin to be installed does not support the non-disruptive upgrade process, then the “NO” branch is taken, and the method proceeds to block 430.

At block 425, the plugin manager may perform the non-disruptive update process of the installed plugin with the plugin included in the installation file package. At block 430, the plugin manager may update the installed plugin by shutting down and uninstalling the installed plugin prior to installing the plugin in the installation file package.

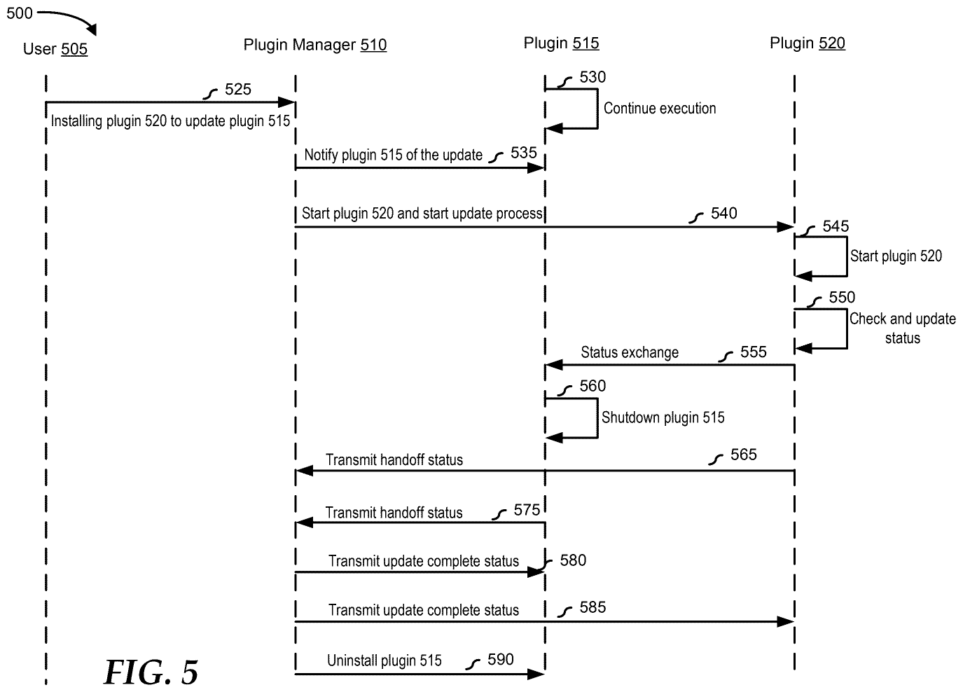

FIG. 5 shows a sequence diagram of a method 500 for avoiding service disruption when updating plugin applications. In particular, method 500 may illustrate block 425 of FIG. 4. Method 500 may be performed by one or more components of environment 200 of FIG. 2 or environment 300 of FIG. 3. For example, user 505 is similar to user 340 of environment 300. In addition, functions of user 505 depicted herein may be performed by plugin controller 245 of FIG. 2. In addition, plugin manager 510 may be similar to plugin manager 325 of FIG. 3 and plugin manager 225 of FIG. 2. Also, plugins 515 and 520 are similar to plugins 315 and 320 of FIG. 3 in addition to plugins 215 and 230 of FIG. 2. However, while embodiments of the present disclosure are described in terms of environments 200 and 300, it should be recognized that other systems may be utilized to perform the described method. One of skill in the art will appreciate that this flowchart explains a typical example, which can be extended to advanced applications or services in practice.

Method 500 typically starts at 525, where user 505 may upload an installation file package to a storage resource of a management controller and start an upgrade process of plugin 515 to plugin 520 via a user interface associated with the management controller and/or a plugin manager 510. The installation file package may be used for firmware upgrade, firmware downgrade, initial driver installation, initial firmware/software installation, etc. Plugin manager 510 may be configured to unpack the installation file package uploaded by user 505 into a secure storage resource in the management controller and read one or more files, such as a manifest file. The installation file package may include one or more files, such as a firmware image of plugin 520 and the manifest file. The manifest may be configured to specify features associated with plugin 520, such as runtime configuration, permissions, and user-visible details about plugin 520, such as vendor name, version, dependencies, etc.

The manifest file may include an entry to indicate support for the non-disruptive update process. For example, the manifest file may include an update flag which can be a variable set during the development of the plugin to indicate whether or not the plugin supports the non-disruptive update process, such as {non-disruptive-update: true}. Thus, the update flag may be a binary variable with a value, such as “1” or “TRUE” to indicate the support of the non-disruptive update process. The update flag may have a value, such as “0” or “FALSE” to indicate non-support of the non-disruptive update process. The manifest file may also include a component identifier associated with the plugin. The component identifier may be used to compare and identify plugins, such as determine whether or not there is a plugin with the same identifier currently installed. If there is a different version of the plugin that is already installed, then the currently installed plugin may be updated. Otherwise, the installation process is treated as a fresh installation of the plugin. At 530, plugin 515 may continue with its execution during the update process.

At 535, plugin manager 510 may notify plugin 515 regarding the start of the update process. Plugin manager 510 may use a remote procedure call to notify plugin 515 that the update process is starting. For example, plugin manager 510 may transmit a D-Bus signal to plugin 515 to indicate that the update is about to start. At 540, plugin manager 510 may also notify plugin 520 regarding the start of the upgrade process. If at this point, plugin 520 may not yet be fully operational, remote procedure calls cannot be transmitted to plugin 520. Accordingly, to indicate that plugin 520 is starting up in an update scenario, a command line parameter, a message passed via a standard socket, or a file may be created by plugin 520 at a particular location. The file can be used as an update flag to indicate that plugin 520 is starting up and/or in a good state in the update scenario. In addition, the update flag may indicate that plugin 520 may start up in an upgrade mode. However, if the remote procedure call is available, then the remote procedure call can be used to indicate that plugin 520 is starting up and/or in a good state. Accordingly, plugin manager 510 may notify plugin 520 regarding the start of the upgrade process using the remote procedure call. At 545, after plugin 520 is successfully installed, it may start up while plugin 515 is running. At this point, plugin 520 may not yet be performing the services provided by plugin 515.

At 550, plugin 520 may check itself and update its status. For example, it may determine whether it is running in a good state or a bad state. In one embodiment, plugin 520 may check whether it can allocate resources and provide the services that are currently performed by plugin 515. Plugin 520 may be given access to a secure storage location wherein persistent information associated with the services is stored. The access given to plugin 520 may be similar to the access to plugin 515. This is performed such that plugin 520 can start with access to the same information that plugin 515 has. In another embodiment, plugin 520 and plugin 515 may be configured to communicate with each other to manage the transition or handoff of services from plugin 515 to plugin 520. For example, plugins 515 and 520 may coordinate the shutting down of a D-Bus service in plugin 515 so that plugin 520 can take over.

At 555, if plugin 520 determines that it is in a good state, then plugin 520 may communicate its status to plugin 515. For example, plugin 520 may notify plugin 515 that it is running and in a good state by sending a D-Bus signal. At 560, after receiving a notification that plugin 520 is running and in a good state, plugin 515 may stop providing the services and start shutting down. At 565, plugin 520 may transmit its handoff status to plugin manager 510, where the handoff status is based on the status exchange at 555. For example, plugin 520 may transmit a D-Bus signal to indicate a successful handoff. The D-Bus signal may indicate that plugin 520 is ready to assume the services provided by plugin 515. At 575, plugin 515 may transmit its handoff status to plugin manager 510. For example, plugin 515 may also transmit a D-Bus signal associated with the successful handoff status to plugin manager 510. Plugin 515 may also notify plugin manager 510 that it has started to shut down.

At 580, plugin manager 510 may transmit an update complete status to plugin 515. At 585, plugin manager 510 may also transmit an update complete status to plugin 520. For example, plugin manager 510 may transmit a D-Bus signal to plugins 515 and 520 to indicate the update complete status. At 590, plugin manager 510 may initiate an uninstall of plugin 515.

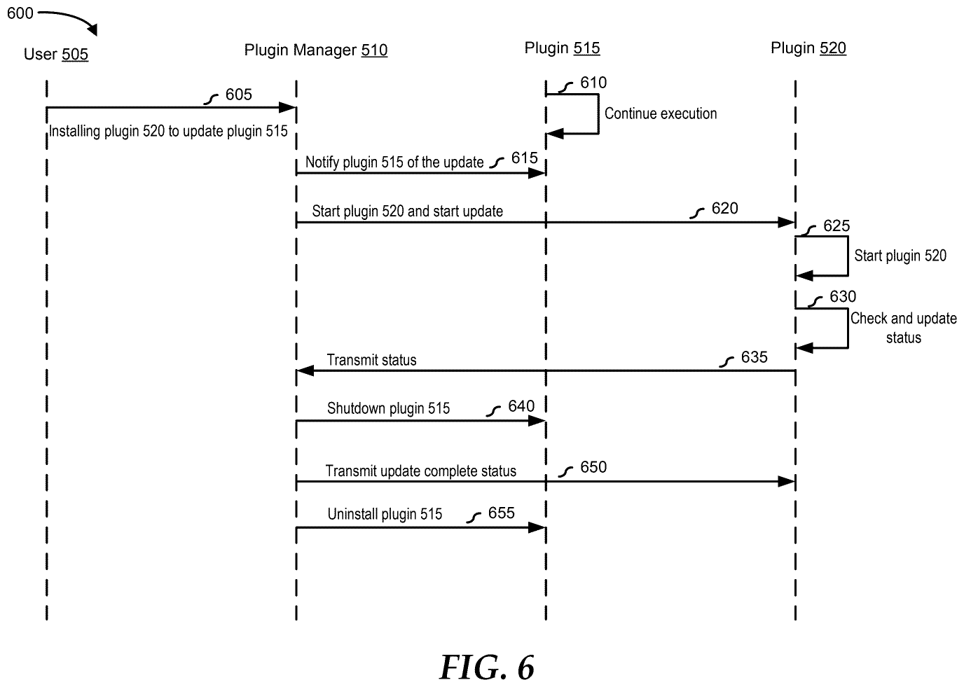

FIG. 6 shows a sequence diagram of a method 600 for avoiding service disruption when updating plugin applications. In particular, method 500 may illustrate block 425 of FIG. 4. Method 600 is similar to method 500 of FIG. 5. However, in this example, plugins 515 and 520 may not be configured to communicate with each other. Instead, plugins 515 and 520 communicate with plugin manager 510 which acts as an intermediary and determines which plugin to shut down and/or uninstall and which plugin would be running to provide services. Method 600 may be performed by one or more components of environment 200 of FIG. 2 or environment 300 of FIG. 3. However, while embodiments of the present disclosure are described in terms of environments 200 and 300, it should be recognized that other systems may be utilized to perform the described method. One of skill in the art will appreciate that this flowchart explains a typical example, which can be extended to advanced applications or services in practice.

Steps 605, 610, 615, 620, 625, and 630 are similar to steps 525, 530, 535, 540, 545, and 550 respectively. As such, at 605, user 505 may install plugin 520 to update plugin 515 while plugin 515 may continue execution at 610. At 615, plugin manager 510 may notify plugin 515 of the start of the update process. At 620, plugin manager 510 may start plugin 520 and proceed to start the update process. At 625, plugin 520 may start running and at 630 proceed to check its state, such as determine whether it is in a good state or a bad state. At 635, plugin 520 may transmit its status to plugin manager 510. For example, plugin 520 may transmit a D-Bus signal to plugin manager 510 that it is running and in a good state. At 640, plugin manager 510 may shut down plugin 515. After receiving a notification that plugin 520 is in a good state, plugin manager 510 may shut down plugin 515. At 650, plugin manager 510 may transmit an update complete status to plugin 520. At this point, plugin 520 may assume the function of providing the services previously provided by plugin 515. At 655, plugin manager 510 may uninstall plugin 515.

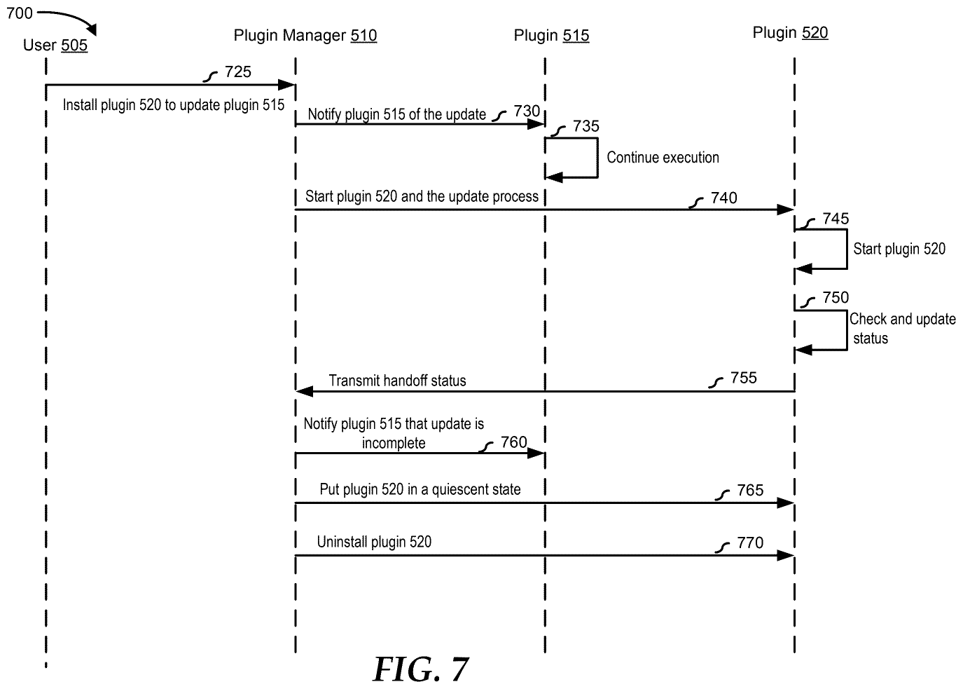

FIG. 7 shows a sequence diagram of a method 700 for avoiding service disruption when updating plugin applications. In particular, method 700 may illustrate block 425 of FIG. 4. Method 700 is similar to method 500 of FIG. 5 and method 600 of FIG. 6. However, in this example, plugin 520 may not run in a good state. Accordingly, the update process may not be completed. Method 600 may be performed by one or more components of environment 200 of FIG. 2 or environment 300 of FIG. 3. However, while embodiments of the present disclosure are described in terms of environments 200 and 300, it should be recognized that other systems may be utilized to perform the described method. One of skill in the art will appreciate that this flowchart explains a typical example, which can be extended to advanced applications or services in practice.

Method 700 typically starts at 725, where user 505 may download and start an update process of plugin 515 to plugin 520. At 730, plugin manager 510 may notify plugin 515 of the start of the update process while plugin 515 may continue with its current execution at 735. At 740, plugin manager 510 may start the execution of plugin 520 and start the update process. At 745, plugin 520 may start up and at 750 may check and update its status similar to step 550 of FIG. 5. In this example, plugin 520 may be in a bad state. At 755, plugin 520 may transmit an update of its status to plugin manager 510. For example, plugin 520 may transmit a D-Bus signal to plugin manager 510 that it is in a bad state and that the handoff failed. Plugin 520 may also log information and/or events that indicate what failed during the upgrade process and corrective actions if any to complete the process.

At 760, after the receipt that the handoff failed, plugin manager 510 may notify plugin 515 that the upgrade process failed and is incomplete. At 765, plugin manager 510 may put plugin 520 in a quiescent or dormant state. Plugin manager 510 may also associate a mark with plugin 520 that indicates that the update failed and may not restart plugin 520 until user 505 corrects the issue that caused the failure. At 770, plugin manager 510 may uninstall plugin 520. Plugin manager 510 may also notify the management controller that the update of plugin 515 failed.

For purposes of this disclosure, the term “plugin” refers to any executable code that can be installed and run on a management controller, but which is not included in the main firmware image of the management controller. Plugins may be installed from an installation file package, such as a Dell® Update Package (DUP) file, used for distributing management controller firmware updates, BIOS updates, drivers, and other packages. One of skill in the art will appreciate that although examples herein refer to an upgrade to a new version of a currently installed plugin, the examples herein can be extended to a downgrade of the currently installed plugin to an older version.

Although FIG. 4, FIG. 5, FIG. 6, and FIG. 7 show example blocks of method 400, method 500, method 600, and method 700 in some implementation, method 400, method 500, method 600, and method 700 may include additional operations, fewer operations, different operations, or differently arranged operations than those depicted in FIG. 4, FIG. 5, FIG. 6, and FIG. 7. Those skilled in the art will understand that the principles presented herein may be implemented in any suitably arranged processing system. Additionally, or alternatively, two or more of the operations of method 500 may be performed in parallel. For example, operations 580 and 585 of method 500 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by a management controller, an installation file package to upgrade a first plugin installed in the management controller to a second plugin included in the installation file package; and
in response to determining that a first component identifier of the first plugin matches a second component identifier of the second plugin, performing a non-disruptive update process, wherein the first plugin and the second plugin support the non-disruptive update process, and wherein the non-disruptive update process includes:
notifying the first plugin that the non-disruptive update process is starting;
installing the second plugin while the first plugin is running; and
uninstalling the first plugin in response to a receipt of a successful handoff status from the second plugin.

2. The method of claim 1, wherein the notifying of the first plugin is performed using a remote procedure call.

3. The method of claim 1, further comprising creating a file to indicate that the second plugin is in a good state.

4. The method of claim 1, further comprising notifying the first plugin that the second plugin is in a good state using a remote procedure call.

5. The method of claim 1, further comprising notifying the first plugin that the non-disruptive update process is complete.

6. The method of claim 1, further comprising in response to receipt of the successful handoff status, uninstalling the first plugin.

7. The method of claim 1, further comprising uninstalling the second plugin in response to receipt of an unsuccessful handoff status from the second plugin.

8. The method of claim 1, further comprising notifying the first plugin and the second plugin of completion of the non-disruptive update process.

9. An information handling system, comprising:
a processor; and
a memory storing instructions that when executed cause the processor to perform operations including:
receiving an installation file package to upgrade a first plugin to a second plugin included in the installation file package; and
in response to determining that a first component identifier of the first plugin matches a second component identifier of the second plugin, performing a non-disruptive update process, wherein the first plugin and the second plugin support the non-disruptive update process, and wherein the non-disruptive update process includes:
notifying the first plugin that the non-disruptive update process is starting;
installing the second plugin while the first plugin is running; and
shutting down the first plugin subsequent to a receipt of a status update from the second plugin that the second plugin is running in a good state.

10. The information handling system of claim 9, wherein the notifying of the first plugin is performed using a remote procedure call.

11. The information handling system of claim 9, wherein the operations further comprise creating a file to indicate that the second plugin is in the good state.

12. The information handling system of claim 9, wherein the operations further comprise determining that the second plugin is in the good state based on a handoff signal.

13. The information handling system of claim 9, wherein the operations further comprise uninstalling the first plugin subsequent to receipt of the status update from the second plugin that the second plugin is running in the good state.

14. The information handling system of claim 9, wherein the operations further comprise uninstalling the second plugin subsequent to receipt of the status update from the second plugin that the second plugin is running in a bad state.

15. A non-transitory computer-readable medium to store instructions that are executable to perform operations comprising:
receiving an installation file package to upgrade a first plugin installed to a second plugin included in the installation file package; and
in response to determining that a first component identifier of the first plugin matches a second component identifier of the second plugin, performing a non-disruptive update process, wherein the first plugin and the second plugin support the non-disruptive update process, and wherein the non-disruptive update process includes:
notifying the first plugin that the non-disruptive update process is starting;
installing the second plugin while the first plugin is running; and
shutting down the first plugin in response to a receipt of a successful handoff status from the second plugin.

16. The non-transitory computer-readable medium of claim 15, wherein the notifying of the first plugin is performed using a remote procedure call.

17. The non-transitory computer-readable medium of claim 15, wherein the operations further comprise creating a file to indicate that the second plugin is in a good state.

18. The non-transitory computer-readable medium of claim 15, wherein the operations further comprise determining that the second plugin is in a good state using a handoff signal.

19. The non-transitory computer-readable medium of claim 15, wherein the operations further comprise notifying the first plugin that the non-disruptive update process is complete.

20. The non-transitory computer-readable medium of claim 15, wherein the operations further comprise uninstalling the second plugin in response to receipt of an unsuccessful handoff status from the second plugin.
